(19) United States
(12) Patent Application Publication
(10) Pub. No.: US 2021/0079978 A1
(43) Pub. Date: Mar. 18, 2021

(54) ARRANGEMENT COMPRISING A CABLE CLAMP AND AT LEAST ONE CABLE

(71) Applicant: Fraunhofer-Gesellschaft zur Foerderung der angewandten Forschung e.V., Muenchen (DE)

(72) Inventor: Roman KRAUS, Frankfurt (DE)

(21) Appl. No.: 16/629,627

(22) PCT Filed: Jul. 9, 2018
(86) PCT No.: PCT/EP2018/068519

§ 371 Date: Jan. 9, 2020

(30) Foreign Application Priority Data
Jul. 10, 2017 (DE) 10 2017 211 724.9

(51) Int. Cl. F16G 11/10; F16G 11/14

(52) U.S. Cl. CPC F16G 11/103; F16G 11/14

(57) ABSTRACT

An arrangement in accordance with the invention comprises a cable clamp and at least one cable. The cable clamp has at least two openings arranged next to one another through which the at least one cable on in each case one cable is guided with the formation of two cable portions passing through the openings. The openings each have a clamping slot in a mutually facing opening region, and the two cable portions are held directly outside adjacent to the openings by a loop of the at least one cable or of further cable by which loop the two cable portions are forceable into the clamping slot.

### CROSS REFERENCE TO RELATED APPLICATION

Reference is made to PCT/EP2018/068519 filed Jul. 9, 2018, designating the United States, which claims priority to German Application No. 10 2017 211 724.9 filed Jul. 10, 2017, which are incorporated herein by reference in their entirety

### BACKGROUND OF THE INVENTION

### Field of the Invention

The invention relates to an arrangement comprising a cable clamp and at least one cable.

### Description of the Prior Art

Cords or rubber bands which are placed around the objects to be fixed and both ends of which are fixed to one another by a knot are frequently used for bundling or fixing objects. However, not everyone is practiced in tying knots and in unfavourable cases knots are difficult to undo again or come undone unintentionally.

So-called cable ties are known as an alternative to knots and are used in many cases. Usually fastenings with cable ties can only be released by cutting through and therefore destroying the cable tie. However, embodiments of reclosable cable ties also exist which can be released again and can thus be used repeatedly. Cable ties consist of a strip having teeth which is usually fabricated from a rigid plastic. For fixing objects the cable ties are guided around this object and one end of the plastic strip is guided into an opening at the other end of the plastic strip. The teeth engage there so that the plastic strip cannot be pulled out of the opening again. In order to ensure that the teeth engage sufficiently firmly on the plastic strip, cable ties employ barely flexible plastic, that is polyamide or POM. Since the plastic strip is barely stretchable, however cable ties form a largely rigid connection. If the fixed objects are exposed to any movement, the cable tie fixing can loosen after some time. In addition, damage to the objects to be fixed can occur as a result of the comparatively rigid material.

In addition to cable ties, so-called hook and loop fasteners are well known and widely used. Hook and loop fasteners in the form of elongate fabric-like strips can, for example, be bound around objects to fix them. They can easily be released again with significant formation of noise. Like cable ties, hook and loop fasteners are also usually not stretchable in the longitudinal direction and therefore are only capable to a certain extent of holding objects under tension in the long term.

Further known fastening elements such as cable clips are frequently also rigid, very restricted in their range of adjustment or complex to handle so that in some cases additional tools are required to tighten them.

Classical rubber bands which are also used in many cases for fixing objects have the advantage, compared with the possibilities already mentioned, that they have a high elasticity and therefore can hold the tension once applied for fixing for a long time. Also the force acting on the object can be readily be controlled as a result of the elasticity. The challenge when using rubber bands is fixing the rubber bands themselves. Usually the rubber bands are knotted for this purpose.

In the case of closed rubber rings, these are usually pulled over the respective object (e.g. a bag) in one layer or multiple layers. For the user, this process is sometimes inconvenient. The objects to be fixed must be held with one hand and the rubber band stretched with the second hand and pulled over the objects to be fixed in the same working step. Furthermore, rubber rings are fixed in length so that in each case, a rubber ring of suitable length must be selected for the fixing task. Frequently it is not possible to pull a rubber ring over the objects to be fixed since these are closed and have no end or the end is inaccessible. For example, in the case of a tree trunk it is rarely possible to pull something over the crown of the tree so that a closed rubber ring cannot be used unrestrictedly to fastening objects.

Expander cables obviate the need for knotting since the rubbers at one or both ends are provided with hooks. However, this results in the disadvantage that the length of the expander cable must fit the respective fastening task. The user cannot freely adjust the length.

Classical tarpaulin tensioners as shown in the document FR1450821A or U.S. Pat. No. 6,389,659 which cannot be continuously adjusted in their length. The cable length in FR1450821A between two balls is largely fixed for the size of objects to be fixed for which the tarpaulin tensioner is particularly suited. It is only possible to respond to different sizes of objects to be fixed by multiple windings, but the effective force is then obtained discretely from the number of windings.

Cable clamps designated as cord stoppers are also known in which the cable is locked by of a stopper element having mechanisms, as indicated for example in U.S. Pat. Nos. 5,697,128 and 5,896,623. The locking or release is accomplished by actuating a mechanism by the user. Such cord stoppers or cable clamps are widely used, for example, as a closure on bags of sleeping bags, as lacing on trousers, jackets or sacks. The security against unintentional release then increases with the restoring force of the mechanism. A disadvantage here is that the user must initially overcome a force to release the mechanism before shifting the cord stopper on the cable. In most cases, such mechanisms are multipart incorporating an additional restoring spring. However, mechanisms are also known which have a single part as shown, as for example, in EP0775845B1.

EP 1029466 discloses in particular a device suitable for tying together hair, which is a rubber band, with both ends which open into a tension element and a displaceable clamping device is mounted on the rubber band loop which is formed, which functions to tighten the loop. Like the already-mentioned classical rubber band, the device described in the cited document must also be pulled over the object to be fixed (end of the hair bundle). In addition, the corresponding clamping device has individual parts, including a restoring spring, which is associated with disadvantages during fabrication and operation. The user must initially release the locking caused by the restoring spring before moving the clamping element along the rubber band loop such which is required to fix an object.

The document GB2042047 discloses a fastening device for cables with a conical elongate hole. The conical elongate hole enables fixing of the cable by way of self-inhibition since the cable is pulled into the tapering region of the elongate hole. However, the cable must be additionally secured against unintentional loosening by use of a knot resembling a crosslay which makes it difficult to use this system.

In U.S. Pat. No. 4,787,660 as in GB2042047, one of the two cable ends is pulled through a tapering cross-section and is thereby fixed. The force required for fixing the cable is only applied during the fixing process so that the cable end can be released from the tapering cross-section again during movements.

U.S. Pat. No. 5,791,022 discloses a tube with two tapering openings in the outer wall through which the two cable ends of the cable are guided. As in the already cited documents U.S. Pat. No. 4,787,660 and GB2042047, the cable is locked by guiding it into the tapered cross-section. The document FR2878925 also uses an outwardly tapering cross-section on the cable clamp to secure a cable and thereby keep bags closed. In these devices, which use a tapering cross-section to fix the cable in the cable clamp, there is usually the risk that the clamped cables can be released again from the clamping region due to an incorrect loading.

US published patent application 2016/108989A describes an element for fastening objects using an elastic double-stranded cable. A cable clamp is anchored firmly on the cable. For fixing an object, the cable loop leaving the cable clamp is guided completely around the body to be fixed and then locked in the cable clamp where the locking can be accomplished at any position of the cable loop. The cable clamp has an opening which is adapted to the cross-section of the cable. During the fastening process, the cable is tensioned and thereby reduces its cross-section so that it can be guided into the groove of the cable clamp. The application NL7700029 is very similar to the afore-mentioned US published patent application 2016/108989A, with the main difference being that a single-stranded design of the cable is used.

U.S. Pat. No. 4,896,403 describes a fastening device for a two-stranded cable in the form of a plastic element having teeth. For locking, a loop of the two-stranded cable is pulled through the plastic element and is secured against release by use of teeth.

The U.S. Pat. No. 5,766,700 describes a fixing element for locking a loop which is guided through the fixing element. The loop can serve to hold or fix a further object. The further object to be fixed then exerts a force on the fixing element with the result that the loop is prevented from being released again from the fixing element.

The document DE6931658U describes a cable clamp, for example, for towing a vehicle. In the simplest embodiment, the cable clamp has only one disk with two elongate holes. The first cable end is fixed in the cable clamp by friction while the second cable end leaves the cable clamp without being fixed by friction. A tensile force must act on this second cable end to hold the first cable end fixed in the clamp. A further object (for example the towing vehicle) can then be fastened to the open cable end.

The document DE6941149U describes a towing cable with a cable clamp for producing a size-adjustable loop. Securing against release is accomplished in the described invention by the towing cable containing clamping nipples at its ends. The diameter of the clamping nipples is larger than the diameter of the cable. In the non-locked state the clamping nipples can be inserted into the cable clamp, but slip during locking into an elongate hole whose gap is selected so that the clamping nipple cannot slip out through the gap.

DE29705188U1 discloses a tensile unit for fastening the two free ends of a ball chain, such as is used for example in Venetian blinds. The tensile unit has two openings with a cross-section tapering towards one another in which balls of the ball chain are positively fixed.

The Utility Model DE20209943U1 describes a device for adjusting the cable length in hammocks. The device employs a cable clamp provided with three holes through which one end of the cable which is used for fixing is guided. The holes have no particular shape. As a result of the cable guidance through the three holes of the cable clamp, a knot is constructed which counteracts the release of the cable.

The application GB2147937 describes a clamp for adjusting the cable length such as, for example, in a similar form as in U.S. Pat. No. 6,389,655 which is widely used for anchoring tents or for fastening equipment to boats. The clamp has an elongate shape and contains two holes for guiding the cable, with the hole diameters being adapted to the cable cross-section. One end of the cable is fixed at one of the two holes while the cable is guided to slide through the second hole.

US published patent application 2004/0194259 or U.S. Pat. No. 7,076,845 describe a cable clamp which has an elongate shape and has one or two holes for guiding a cable along this shape. The guided cable can loop around an object to fix it and is then guided back again and pulled around the two ends of the elongate cable clamp. In order to hold the fixing, however a tensile force must be applied continuously to the complete cable. Accordingly, the cable end facing away from the fixing region cannot remain loose and a tensile force must be applied. The subject matter described in the application EP2101081 is comparable to the structure from the US published patent application 2004/0194259 but the one or both holes are formed by grooves instead of through holes.

A further fastening element is disclosed in the Greek document GR20100100420A. Described therein is a cable, with both ends being interconnected via an additional element to form a loop from the cable. In addition, a further element is located on the loop, which contacts the two strands of the loop and is displaceable on the loop. In order to fix an object, the loop can be guided around this object and the additional element is guided through the loop after the loop has completely enclosed the object. For further fixing of this fragile fastening, a slider, starting from the additional element, is displaced in the direction of the object. By this means, the loop surrounding the object is tightened even further and locked as a result of the friction of the slider on the cable. However, the slider is barely secured against being removed again from the object to be fixed and thus undesirably releasing the fastening again.

It is known that some cable clamps can result in damage to the objects to be fixed. In the already cited application GB2147937 a cable clamp is described which contains specifically elastic regions in order to avoid such damage.

In some of the cited documents, in particular U.S. Pat. Nos. 5,791,022 and 4,787,660 and in GB2042047, the cable or cables are guided through a tapered cross-section on an additional component (of the cable clamp) during the fastening process. The tapering cross-section results in an increase in the frictional force between cable and cable clamp and thereby secures the cable against release. If an unfavorable load, in particular a force contrary to the direction of the tapering, acts on the cable, there is therefore nevertheless the risk that the cable is released from the cable clamp again.

In US published patent application 2017/0108081 a fastening device is described which comprises a closed cable or a closed band which is divided by a firmly bonded connection or via a separate element into a smaller and into a larger loop. In the region of the larger loop, an elongate toggle button is arranged which is penetrated transversely by two parallel through openings through which the cable portions of the larger loop are guided. The through openings can be configured to be conically tapering in the axial direction in order to prevent any slippage of the cable portions in one direction. The toggle button is arranged displaceably along the larger loop for the purposes of a length adaptation of the fastening element. The fastening element can be used in various ways, specifically to form a simple, a double or a self-inhibiting closure.

FR 2 445 462 A2 discloses a hook element with a through opening which penetrates the hook element transversely, through which an elastic cable can be guided. The opening has a first opening region with round cross-section whose cross-section is larger than the cable cross-section. The first opening region partially intersects a second round opening region whose cross-section is equal to the cable cross-section in the relaxed state so that the cable can still slide through the second opening region. In the region of the intersection, two projections are formed between which, on the one hand, the cable can be pulled through under elastic deformation but which on the other hand prevent an unintentional slipping back of the cable from the second into the first opening region. The second opening region is followed by a groove-shaped clamping portion in which the cable can be clamped.

FR 2 855 227 A1 describes a cable clamp which is configured in the form of a flat elliptical cylinder and which is penetrated by an opening in the axial direction. This has a first opening region through which the cable can be guided without clamping. The first opening region goes over into a second narrowly tapering opening region in the radial direction into which the cable fastened to the cable clamp on one side can be drawn and clamped.

DE 199 06 120A1 describes a device for continuously adjustable fixing of the size of a cable loop which is wrapped around an object. The device has a holding part for one end of the cable and a clamping part for detachable firm clamping of the cable running back after the loop formation. The clamping part is configured as a cable guiding channel whose side wall have toothed ribs.

### SUMMARY OF THE INVENTION

The invention is based on providing an uncomplicated arrangement having a cable clamp and at least one cable used for at least one of fastened and holding objects together which is easy and cheap to manufacture, easy to use and which is reusable.

According to the invention, which comprises a cable clamp and at least one cable is characterized, the cable clamp has at least two openings arranged next to one another through which the at least one cable or in each case one cable is guided with the formation of two cable portions passing through the openings. The openings each have a clamping slot which mutually faces and opening region. The two cable portions are held directly outside adjacent to the openings by a loop of the at least one cable or a further cable with the two cable portions being configured to be forced into the respective clamping slots. In particular, the two cable portions can be forced into the respective clamping slot by their loops being oriented towards one another.

In a preferred embodiment, the at least one cable or the further cable is elastically stretchable or is connected to at least one elastically stretchable coupling element, which results in elastic restoring force forces the cable portions towards one another into the clamping slots. The at least one coupling element can be a section in the at least one cable or in the further cable which has a higher elasticity than the corresponding cable. The coupling element can, however also be configured in the manner of a longitudinally elastic spring which connects the cable ends of the at least one cable or the further cable. However, a coupling of at least one cable end, and preferably of both cable ends, to an object via one or one coupling element each is also feasible. An elastic restoring force counteracting the preceding stretching along the at least one cable or the further cable has the effect in the region of the loop that would contract. This results in an inwardly directed force which forces the cable portions towards one another into the respective clamping slots. It is particularly advantageous that this force or pre-tensioning of the cable resulting from the stretching even under unfavourable loads such as could occur as a result of mutual movement of objects to be fastened to one another, holds the cable portions in the clamping slots. The cables can be configured identically or differently. In particular, the cables can comprise precisely one fiber or several fibers. Particularly suitable as materials for the cable or cables are elastomer materials and rubbers or elastically woven bands. Particularly preferably is at least one cable, or at least one of the cables and the further cable has a Shore A hardness in the range of 40-80 and an ultimate elongation of at least 100%. In order to improve the handling and protect the cable, the at least one cable and at least one of the cables and the further cable can be an elastomer material which is clad with a woven fabric.

In a particularly preferred embodiment, the cable clamp is fabricated in one piece. Preferably, the cable clamp is fabricated from a rigid material but should at least be fabricated from an elastic material having less elasticity than the at least one cable, the cables or the further cable. Particularly suitable as material for the cable clamp are plastics such as polyamide, POM, ABS, PC, PE, PVC or plastics which are comparable in their hardness range, metals such as aluminium or steel, wood and/or materials having an elastic modulus of at least 100 MPa or a Shore D hardness in the range of 50-90. The cable clamp comprises a body with a longitudinal extension which is greater than its transverse extension. Preferably the cable clamp has an overall length in the longitudinal extension direction which corresponds to at least five times, and particularly preferably at least seven times the diameter of the undeformed cable. The openings penetrate the body in directions which are oriented parallel to the transverse extension direction or at an angle of <30° to the transverse extension direction. The openings do not in this case have to be parallel to one another. The respective penetration direction can be defined as an imaginary connecting line between the centers of gravity of the inlet or outlet surfaces of the respective opening.

Preferably, the openings each have a cross-sectional shape which tapers continuously or stepwise in the direction of the other opening. In this case, the cross-sectional shape in the tapered region has at least one region having a clear width with w<0.7 dₛ, preferably w<0.6 dₛ, particularly preferably w<0.5 dₛ which is part of the clamping slot.

In particular, the cross-sectional shape of the cable portions is deformed by the clamping slot, for example, from circular to a flattened shape. In addition to the change in the cable cross-section, a displacement of the cable material in the cable direction can also occur due to the clamping. Depending on the elastic properties of the cable or the cables, the cable cross-section with greater or smaller distance from the openings again approaches the circular shape with the diameter dₛ. The cross-sectional shape of the openings has an extension in the longitudinal extension direction or in a direction perpendicular to the respective penetration direction, here designated as width, which has a first region and a second region and in total corresponds to at least twice the cable diameter dₛ. Particularly preferred here is a width b₁ of the first region where b₁≥1.3*dₛ and a width of the second region where b≥1.5*dₛ.

Preferably the openings are configured to be mirror-symmetrical where a normal vector of the symmetry plane is oriented parallel to the direction of the longitudinal extension. Particularly preferably is when the openings are configured to be mirror-symmetrical and parallel.

Each of the clamping slots preferably has at least two mutually facing contact surfaces with which the cable portions come in contact at least during clamping. In this case, at least one of the contact surfaces can have a surface structuring for increasing frictional forces acting between the cable portions and the clamping slots. The contact surfaces are formed by opposite opening wall portions which delimit the opening.

In a further preferred embodiment, the cable clamp has a slit which completely penetrates the cable clamp wherein the openings are interconnected in the region between the clamping slots via the slit in such a manner that the cross-sectional shapes of the openings go over into one another to form a single closed contour. This embodiment can have advantages during manufacture since with a cable ring, for example, a closed rubber band, can be introduced subsequently into the cable clamp, which is no longer possible with two separate openings or holes. Alternatively, the cable clamp can have two slits which make the openings each accessible from outside from the longitudinal extension direction. It is also possible to subsequently introduce a cable ring since the two openings or holes are held open to the outer region of the cable clamp by the slit. In principle, therefore in each of these preferred embodiments, the cable portions can be introduced into the openings via the one slit or the slits transversely to the respective penetration direction.

Preferably the cable clamp has two surface portions into which the openings each open wherein at least the surface portions on the side of the loop are configured to be concave in a region which comes in contact with the loop. As a result of the concave configuration of the cable clamp in the direction of the penetration direction of the openings or the penetration direction of the guided cable portions, the force of the first loop on the two strands is increased in the direction of the clamping slots or in the direction of the second region. The security against release is thereby further increased.

In a preferred embodiment, the cable ends are connected directly by means of a firmly bonded, positive or non-positive or frictionally engaged connection or indirectly by means of a connecting element or a tensile element to form a closed cable ring, so that on both sides of the cable clamp respectively one loop, namely a first loop and a second loop are formed. In this case, the loop is part of the first loop and embraces the cable portions on the side of the first loop or on the side of the second loop. The tensile element simplifies the handling of the arrangements since it is not necessary to pull directly on the cable or on the cables. In addition, the tensile element can be used as connecting element during the manufacturing process in order to connect or close an open cable, for example, a rubber band to form a cable ring.

Preferably the cable clamp can be assigned a first and a second side relative to a plane perpendicular to the transverse extension direction. On the first side of the cable clamp first cable portions adjoining the cable portions are connected indirectly or directly to a first object. On the second side of the cable clamp second cable portions adjoining the cable portions are interconnected or at least one securing means is arranged thereon, by means of which a complete pulling of the second cable portions through the openings can be prevented. The further cable is fixed with its loose ends on the first object or a second object to form a loop. Instead of the attachment of two cables to the first object, a loop or two open ends of a cable can be guided through an opening penetrating the first object. In this case, the first cable portions and the second cable portions are part of the same cable. In the simplest case, knots at the cable ends can serve as securing means, the diameter of which is greater than the clear width of the openings. A securing ring through which the open cable ends are guided is also feasible however.

In a further preferred embodiment an additional element, in the form of a clamping ring with at least one through opening is provided through which cable portions emerging from the cable clamp can be guided and by means of which the emerging cable portions have a spacing which corresponds to the spacing of the cable portions guided in the openings when these are fixed in the clamping slots.

In a further preferred embodiment the surface structuring is configured to be spatially directed. The surface structuring has at least one, preferably two or more ribs which are arranged on the at least one contact surface and which enclose an angle between 0° and 15° with the transverse extension direction.

The advantage of the arrangement according to the invention is in that most diverse objects can be fixed to themselves or to further objects. In particular, the arrangements can be used in manifold ways for fastening, winding around, bundling or closing items of various size. After use the arrangement can be easily released without destruction and can then be reused. The action of force on the object to be fixed can be adjusted continuously and realigned even after it has already been fixed. When using an elastic cable, for example, a rubber band, as a result of the elasticity of the rubber band, the action of force still persists even when the object moves or is exposed to vibrations. No additional mechanism for fixing needs to be actuated by the user. The use of elastic cables and the manner of looping around furthermore has the advantage that the objects to be fixed are only contacted by the cable or the cables of elastic material but not or at least only with a small application of force, by the cable clamp so that the risk of damage to the objects to be fixed is low. The components required for the arrangement according to the invention can be produced simply and cost-effectively. It is particularly advantageous that no loop adapted to the size of the cable clamp which has been pre-assembled or produced by means of an additional connecting element need be provided.

An incomplete list of possibilities for which the invention can be used is listed in the following:

binding together cables and hoses,

holding together pins, tubes, cutlery, tools, branches, . . .

closing books, notebooks, files, bags, pouches, bags for sleeping bags, sacks, . . .

closing bags, rucksacks, items of clothing, shoes, . . .

fixing plants, e.g. tomato bushes, to a stake

binding together rolls (posters, paper, wrapping paper, plastic film, sleeping mats)

pinching off blood vessels, e.g. for measuring blood pressure

fastening chains of lights to trellises, branches, railings, . . .

fastening hammocks and other swings to a tree

fastenings items such as babyphones, cuddly toys to cots

fastening items such as drinks bottles and lamps to bicycles

fastening items such as navigation devices, mobile phones, screens in the vehicle to head supports, interior mirrors, steering wheel, ventilation grids

anchoring cables, e.g. for tents or washing lines

### BRIEF DESCRIPTION OF THE DRAWINGS

The invention is described hereinafter without restricting the general inventive idea by means of exemplary embodiments with reference to the drawings. In the figures, in schematic view in each case:

FIGS. 1a, b, c, and d each show a cable with a cable clamp which can be arranged according to the invention.

FIG. 2a shows a basic form of a cable clamp in perspective view with angles of α, α′ of 0°.

FIG. 2b shows a basic form of a cable clamp in perspective view with angles α, α′>0°.

FIG. 2c, and d show a cable clamp with cable sections in cross-sectional view.

FIGS. 3a, b, and c show a first embodiment of the invention with a diagram without objects being fixed and in two different variants with fixing of several objects to one another.

FIG. 4 shows a second embodiment of the arrangement according to the invention without objects being fixed.

FIG. 5a, and b show a second embodiment in two different variants without objects being fixed.

FIGS. 6a, and b show a cable clamp with one or two slits.

FIG. 7 shows a cable clamp with free-form openings.

FIGS. 8a, and b show cable clamps with different body shapes.

FIGS. 9-11 show cable clamps with different body shapes.

FIG. 12 shows a cable clamp with a handle structure on the body.

FIGS. 13a, and 13b show a cable clamp with nonlinear tapering of the cross-sectional shape of the opening.

FIG. 14 shows a cable clamp with contact surfaces having a directional structuring.

### DETAILED DESCRIPTION OF THE INVENTION

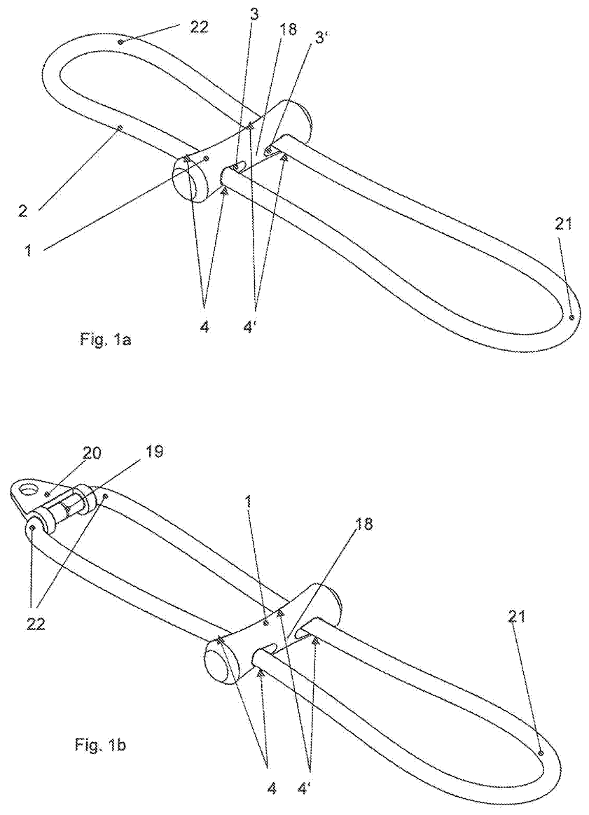

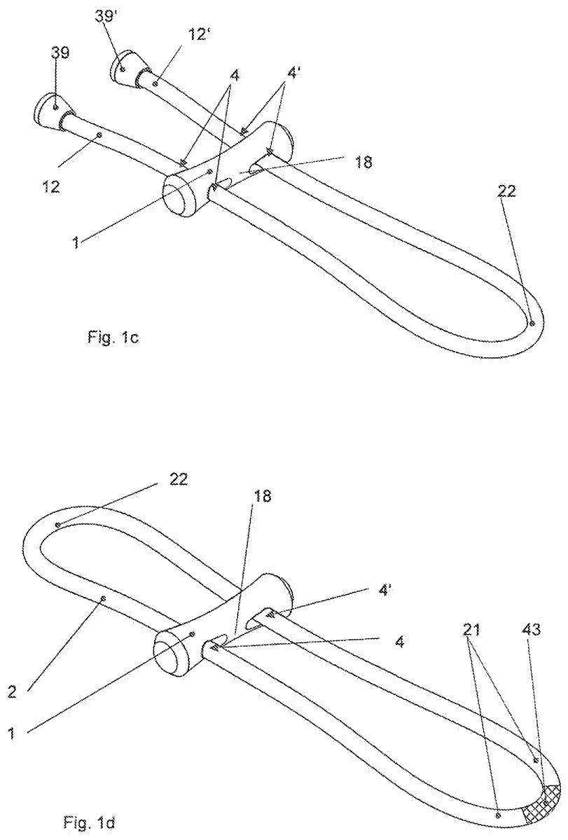

FIGS. 1a-c show different embodiments of an arrangement comprising a cable clamp and precisely one cable which can be arranged according to the invention for fixing objects. FIG. 1a shows the simplest case of a cable clamp 1 and a closed cable ring 2, for example, in the form of a closed rubber band, in which the rubber band is guided through two openings 3, 3′ of the same type in the cable clamp 1. The rubber band is then divided by the cable clamp 1 into two sides, which each form a rubber band loop 21, 22 starting from the cable clamp 1. The loop size is changed by displacement of the cable clamp along the cable or the cable portions. The two openings 3, 3′ of the cable clamp 1 are here arranged parallel and have mirror-symmetry and have a tapering opening cross-section, with the two openings 3, 3′ tapering towards one another. For assembly the cable 2 with the open ends can be guided through the openings 3, 3′ and then joined in a firmly bonded manner, non-positively or positively (FIG. 1a) or by means of a connecting element 20 (FIG. 1b). In FIG. 1b additionally or alternatively to the connecting element 20, a firmly bonded, non-positive or positive connection 19 of the cable ends is indicated. The connecting element 20 shown in FIG. 1b can also serve as tensile element and improve the handling of the arrangement whereby it is not necessary to pull directly on the cable. The cable ends can also be connected merely by knotting (not shown). FIG. 1c shows a further variant in which the cable ends are each secured individually against unintentional sliding out from the openings 3, 3′. For this purpose, for example, a securing means 39, 39′ can be attached to each cable end or a knot can also serve as such at the cable end, as shown in simplified view in FIG. 1c.

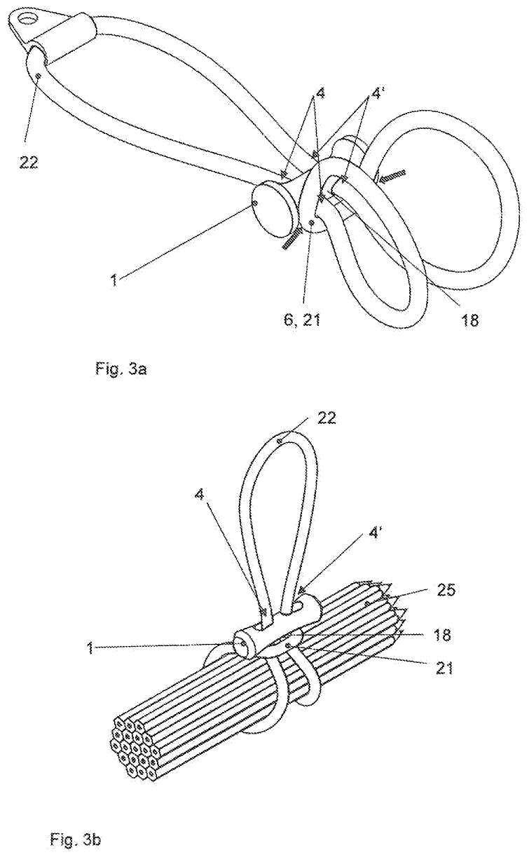

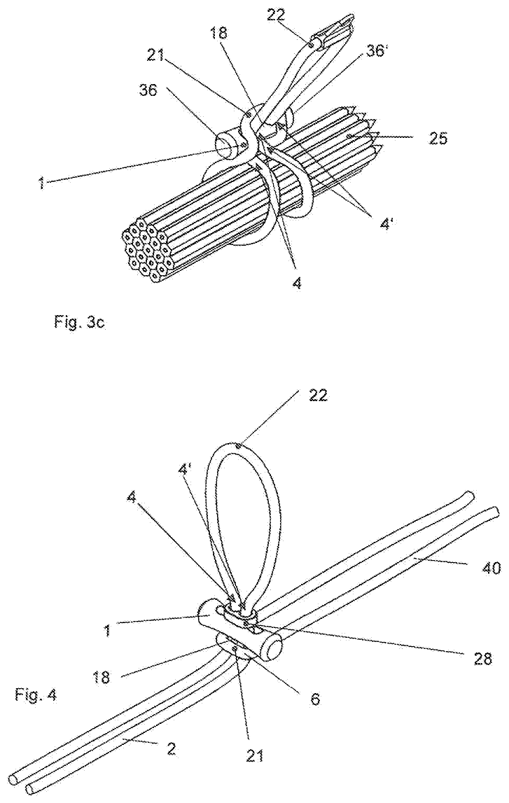

FIG. 1d shows a cable 2 with an elastic coupling element 43. In this case, the cable 2 itself and also the part of the cable which subsequently forms the loop 6 (FIG. 3a) can have a lower elasticity. The restoring force which forces the cable portions 4, 4′ into the clamping slots 5, 5′ then results from an elastic stretching of the coupling element and is imparted via the cable. Such a coupling element can, for example, be an elastic spring.

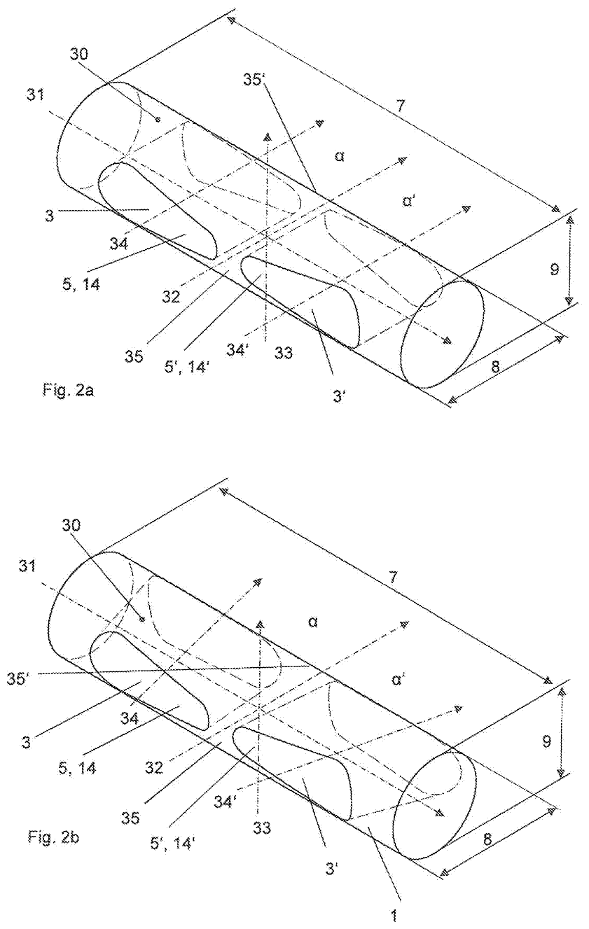

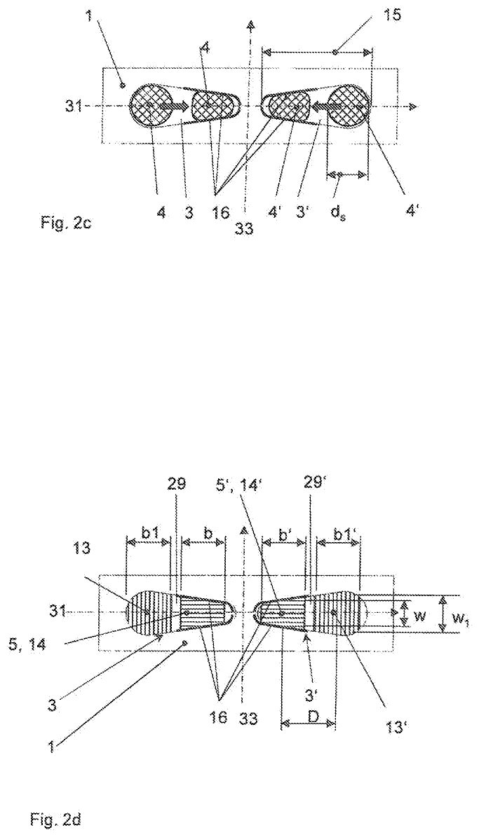

FIG. 2a shows the fundamental structure of the cable clamp 1. This has a body 30 with a longitudinal extension 7 in the longitudinal extension direction 31 and a transverse extension 8 in the transverse extension direction 32 and a vertical extension 9 in the vertical extension direction 33. The openings 3, 3′ penetrate the cable clamp completely in the penetration direction which here coincides with the transverse extension direction. The openings 3, 3′ here for example have a cross-sectional shape which consists of segments of a large and a small circle which are each connected via straight lines which open tangentially onto the circles. The openings 3, 3′ therefore have tapering opening regions 14, 14′ which form the clamping slots 5, 5′.

The penetration directions 34, 34′ of the openings need not however be aligned parallel to the transverse extension direction 32 nor do the openings through the cable clamp 1 need to have the same cross-sectional shape or cross-sectional area. Thus, for example, the cable clamp 1 shown in FIG. 2b, for example, has openings 3, 3′ with penetration direction 34, 34′ which enclose an angle α, α′≠0° with the transverse extension direction 32. Furthermore, FIG. 2b also shows openings 3, 3′ whose cross-sectional area through the cable clamp is not constant but widens towards the rear in penetration direction 34, 34′ in FIG. 2b.

FIG. 2c shows the cable clamp 1 in cross-section together with the cable portions 4, 4′ in each case before and after clamping. It is possible to see the clear reduction in cross-section and change in cross-sectional shape experienced by the cable portions 4, 4′, which preferably have a round cable cross-section in the undeformed state, on entry or in the clamping slot.

In FIG. 2d the various opening regions are specified in detail. The openings 3, 3′ have a cross-sectional shape with respectively one first region 13, 13′ and respectively one second region 14, 14′. The first region 13, 13′ is preferably adapted to the cable cross-section in such a manner that the cable or the cable portions 4, 4′ in the undeformed state or in only a slightly stretched state in which the cable portions 4, 4′ only experience a slight reduction in cross-section, preferably less than 20% of the cross-sectional area, can be pulled through the cable clamp without experiencing any clamping. Any sliding of the cable clamp without external action can however be avoided by such a dimensioning of the first region 13, 13′. The first region 13, 13′ preferably has an extension in the longitudinal extension direction b₁, b₁′ which at least corresponds to the cable diameter dₛ.

The second region 14, 14′ has a reduced clear width with w<0.7dₛ, preferably w<0.6dₛ, particularly preferably w<0.5 dₛ. The second region 14, 14′ defines the contour of the clamping slot 5, 5′ of the respective opening 3, 3′ in the cross-sectional plane being considered. The second region 14, 14′ preferably has at least one extension in the longitudinal extension direction b, b′ which at least corresponds to the cable diameter dₛ. Preferably the first region 13, 13′ and the second region 14, 14′ have a distance D from one another starting from the respective center of the region which corresponds at least to the cable diameter.

If the cable portions 4, 4′, which have a circular cable cross-section in the undeformed state, are introduced into the second region 14, 14′ or into the clamping slot 5, 5′, these undergo at least one cross-sectional deformation so that they acquire a flattened cross-sectional shape adapted to the contact surfaces 16 (FIG. 2c). As a result of the cross-sectional variation, restoring forces are induced in the cable portions 4, 4′ which result in a pressing of the cable portions 4, 4′ onto the opposite contact surfaces 16 of the clamping slots 5, 5′ and thus in an increase in friction between the cable portions 4, 4′ and the contact surfaces 16. When the clamping slot is suitably configured, the contact surfaces 16 can go over into one another. Due to the increased friction the cable clamp 1 can no longer be shifted along the cable 2 or only with significantly higher force. A further increase in the frictional forces between the deformed cable portions 4, 4′ and the contact surfaces 16 can be achieved by the contact surfaces 16 having a friction-increasing surface structuring at least in part.

In addition, this deformation or squeezing can also result in a lengthening of the cable portions. The restoring force induced by the lengthening of the cable portions brings about an increase in the clamping force.

A transition region 29, 29′ can extend between the first region 13, 13′ and the second region 14, 14′ in which the cross-sectional shape of the opening 3, 3′ tapers continuously or abruptly.

FIG. 3a shows how a section of the loop 21 forms the loop 6 which pulls the cable portions running in the openings 3, 3′ into the clamping slots by application of an elastic force directed in the direction of the tapering of the openings 3, 3′ (see arrows in FIG. 3a and also arrows in FIG. 2c) and counteracts any emergence of the cable portions from the clamping slots. FIGS. 3b and 3c show two variants as to how the arrangement according to the invention can be used for fixing objects, here for example, for bundling pins 25. The first loop 21 is guided around the objects/pins 25 and then pulled over the second loop 22 and the cable clamp 1. The first loop 21 embraces the pins 25 and the portions of the first loop 21 emerging from the cable clamp 1 (or the second loop 22 in FIG. 3c). For locking the arrangement, the second loop 22 is now pulled away by the user from the objects/pins 25 to be fixed and the cable clamp 1, wherein the cable clamp 1 is pressed by the user towards the objects/pins 25 to be fixed. By this means a tensile stress is exerted on the first loop 21 which results in the penetration of the two cable portions 4, 4′ into the tapered second regions 14, 14′ of the openings 3, 3′ which comprise the clamping slots 5, 5′ and thus locks the two cable portions 4, 4′. Since the tensile stress on the first loop 21 is also maintained during slight movements, the two cable portions 4, 4′ are held and secured in the tapered second regions 14, 14′ which are part of the respective clamping slots 5, 5′. The fastening is now completed. To release the connection it is sufficient to pull the cable clamp 1 away from the fixed objects 25.

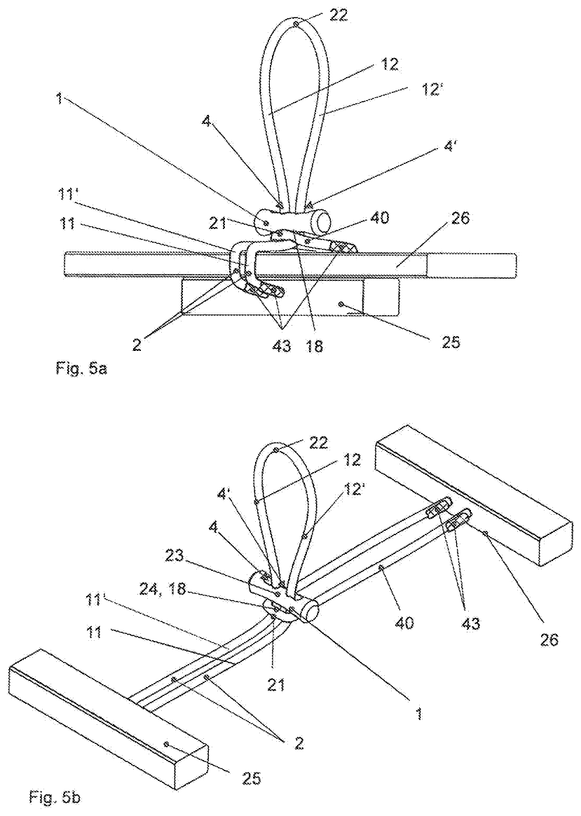

One possibility for fixing an object to another can be achieved whereby the first loop 21 is guided through an eye or an opening in one of the objects and then pulled over the second loop 22 and the cable clamp 1. This results in a similar arrangement as in FIG. 5a only with the difference that cable ends from two different cables are not fixed on the object 25 but the first loop 21 is guided through an opening in the object 25 (not shown in FIG. 5a).

An alternative possibility as to how the first loop 21 can embrace the cable clamp 1 is shown in FIG. 3c. In this variant, the first loop 21 is pulled over the two longitudinal ends 36, 36′ of the clamp 1 instead of needing to be guided over the second loop 22. In this variant also this results in an action of force from the first loop 21 onto the two cable portions 4, 4′ guided through the clamp so that these are pressed and locked in the tapered second regions 14, 14′ of the openings 3, 3′.

FIGS. 4 and 5a and 5b show a second embodiment of the arrangement according to the invention in which a cable 2 is guided through the cable clamp 1 forming a loop and the loop 6 is formed by a portion of a further cable 40. The two open ends of the cable 2 and the further cable 40 can be fastened to the same object 25 (FIG. 5a) or to two different objects 25, 26 (FIG. 5b), wherein the two different objects 25, 26 can each be part of a further object. Thus, for example according to FIG. 5a the object 25 connected to the cables of the arrangement according to the invention can be fixed to the object 26.

In order to fix the object 25 to the object 26, as shown in FIG. 5a, the first loop 21 is guided in a first direction and the second loop 22 is guided in a second direction around the object 26 and the first loop 21 is pulled over the second loop 22 and the cable clamp 1 so that both loops jointly embrace the object 26. The loop 22 is then pulled away from the object 26 by the user whilst the cable clamp 1 is pressed towards the object 26 by the user. By this process a tensile stress is applied to the first loop 21 which leads to the locking of the two cable portions 4, 4′ in the clamping slots 5, 5′ (not visible in FIG. 5a). Optionally elastic coupling elements 43 are indicated in FIGS. 5a and 5b which have a higher elasticity than the cable 2 or the further cable 40. Such a coupling element 43 can be an elastically stretchable cable which is part of the at least one cable 2 or the further cable 40, an elastic spring or an elastic part of objects to be fixed, such as for example an elastic fabric on a sack from which the cables lead out.

In order to fix the object 25 on the object 26, as shown in FIG. 5b, the first loop 21 is pulled over the second loop 22 and the cable clamp 1 so that it embraces the sections of the second loop 22 emerging from the cable clamp 1. For tightening the arrangement, the cable clamp is held firmly by the user and is pulled on the second loop 22 so that parts of the cable pieces 11, 11′ are pulled through the cable clamp and the loop 22 is enlarged forming a tensile stress. The tensile force acting between the object 25 and the object 26 is specified by the size of the tensile force exerted by the user between the cable clamp 1 and the loop 22. A force equilibrium is then established between the cable pieces 11, 11′ and the further cable 40 so that a tensile force acting on the cable 40 and the first loop 21 has the result that the two cable portions 4, 4′ are pulled into the clamping slots 5, 5′.

Instead of the one cable 2 which is guided through the cable clamp 1 forming a loop, alternatively two separate cables (not shown) can be guided through the openings 3, 3′ of the cable clamp 1 whose ends are connected in a firmly bonded manner, non-positively or positively so that a type of loop is again formed. The ends can also remain open.

In a preferred embodiment, a securing element/additional element 28 in the form of a displaceably mounted clamping ring can be provided (FIG. 4) which is arranged on the side of the cable clamp facing away from the loop and by which the cable portions are held directly outside the cable clamp 1 at a distance from one another which corresponds to the spacing of the cable portions 4, 4′ in the clamping slots 5 (FIG. 4). If the clamping ring 28 is pushed towards the cable clamp 1, this also brings about a force on the two cable portions 4, 4′ in the cable clamp 1 in the direction of the tapering. The security against release can be further increased with such a clamping ring 28.

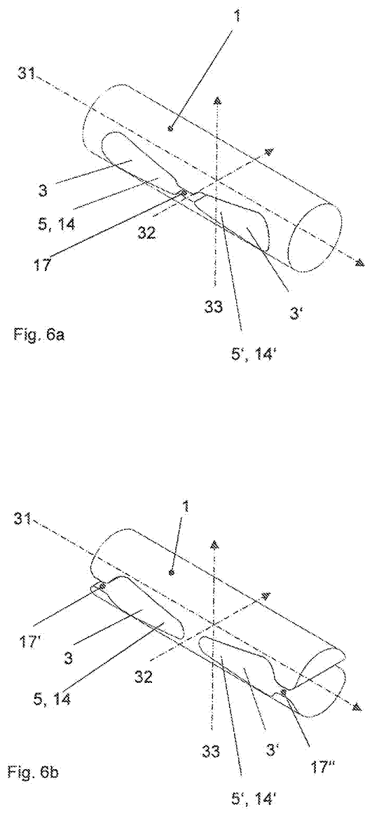

FIGS. 6a and 6b show two embodiments for the cable clamp in which a previously closed cable ring can still be assembled with the cable clamp 1. For this purpose, the cable clamp 1 according to FIG. 6a has a slit 17 which completely penetrates the cable clamp 1 like the openings 3, 3′ and which connects the two openings 3, 3′ over their entire extension through the cable clamp 1. A cable portion of the cable ring can then be pulled over through the slit 17 from one of the openings e.g. 3 into the other opening, e.g. 3′.

Alternatively, according to FIG. 6b, the openings 3, 3′ can be opened completely outwards through respectively one slot 17′, 17″, i.e. over their entire extension in the penetration direction so that the cable portions 4, 4′ of the cable ring can be inserted from outside into the openings 3, 3′. It is particularly advantageous if the slit width is smaller than the cable diameter dₛ so that the cable clamp 1 cannot be released unintentionally from the cable ring. Naturally, the slit width must be selected to be suitably large taking into account the elastic properties of the cable 2 and the cable clamp 1 so that the cable portion or the cable portions 4, 4′ can be pulled through the slit 17 or the slits 17′, 17″ transversely to the cable direction.

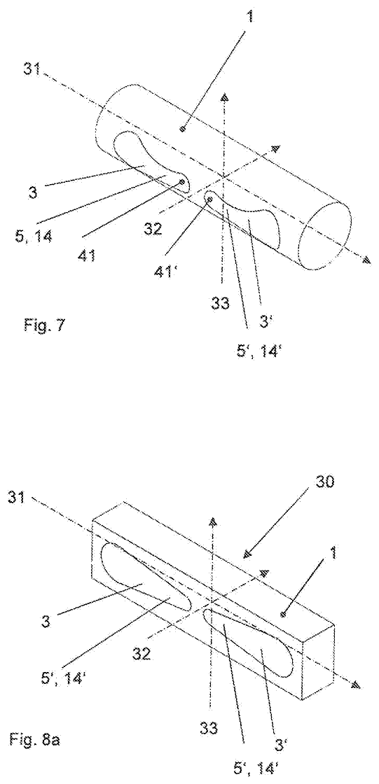

FIG. 7 show two openings 3, 3′ with an alternative cross-sectional shape. The slight widening 41, 41′ of the openings 3, 3′ in the direction of the other opening in each case has the effect that the user of the cable clamp can tactilely perceive a type of engagement when locking the cable portions in the clamping slot. However, the widened region is still not sufficiently narrowly dimensioned that a clamping of the cable can take place in this region. The openings 3, 3′ here have a two-dimensional cross-sectional shape which is configured to be asymmetrical in relation to the longitudinal extension direction 31. In general, an asymmetrical configuration of the cross-sectional shape can be suitable to adapt the tapering direction of the openings 3, 3′ to the direction of the force acting ultimately on the cable portions 4, 4′ from the loop 6 (see arrows in FIG. 3a).

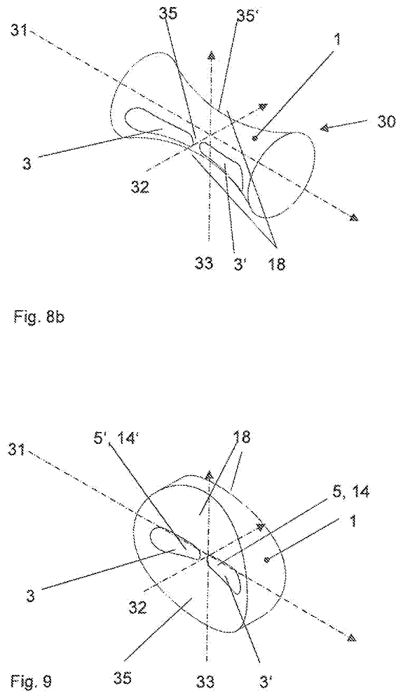

FIG. 8a shows a body 30 of a cable clamp 1 in which the surfaces into which the openings 3, 3′ open are planar. In contrast to this, FIG. 8b shows a cable clamp 1 with a waisted body 30. This has a concave line 18 at least in the longitudinal extension direction 31 so that the contraction of the loop 6 as a result of the elastic restoring forces acting along the cable 2 is facilitated. FIG. 9 shows a cable clamp 1 configured to be button-like in which at least one of the surfaces is concavely arched. Here also the concave shape 18 serves to intensify the force action of the loop 6 on the two cable portions emerging from the clamp 1 and thus to increase the security against release of the cable clamp 1.

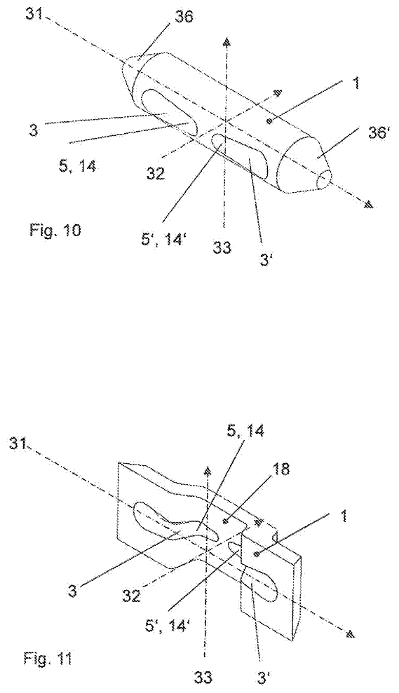

FIGS. 10-12 show further different embodiments of the cable clamp. FIG. 10 thus shows an elongate cable clamp 1, the ends 36, 36′ of which are not configured to be planar but taper, for example, taper to a point. However, the ends 36, 36′ can also be rounded. Due to the tapering ends 36, 36′ the first loop 21, for example, can be pulled more easily over the cable clamp 1, thus improving the handling.

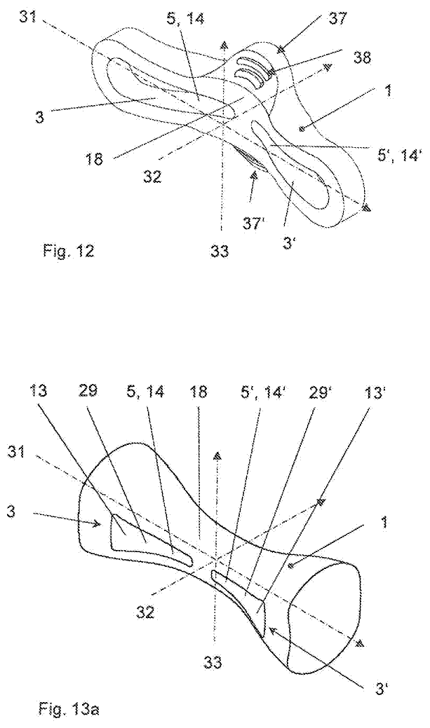

FIGS. 11 and 12 show cable clamps, the bodies of which are bent in the transverse extension direction 32 and thus form a concave region 18 at least on one side so that the drawing together of the loop 6 as a result of the elastic forces acting along the cable 2 is facilitated. The cable clamp 1 shown in FIG. 12 additionally has broadened regions 37, 37′ in the vertical direction which are fitted with a grip structure 38. This shaping additionally facilitates the handling of the cable clamp 1.

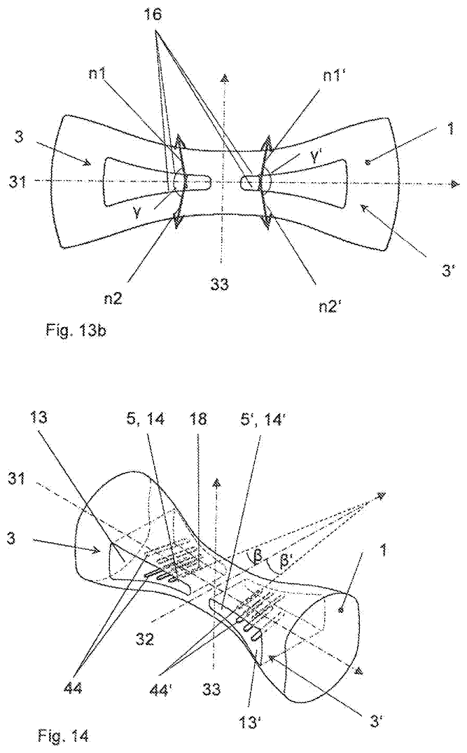

FIGS. 13a and 13b show a further advantageous embodiment of a cable clamp 1. The cable clamp 1 is characterized by a nonlinear tapering of the cross-sectional shape of the opening 3, 3′ from the first region 13, 13′ over the transition region 29, 29′ to the second region 14, 14′. In the second region 14, 14′ the contact surfaces are oriented almost parallel to one another, i.e. the normal vectors n1, n1′ of the lower contact surfaces 16 shown in FIG. 13b enclose an angle γ, γ′ of 165° to 180° in the second region with the normal vectors n2, n2′. The resulting only slight change in the clear width w, w′ of the opening 3, 3′ in the second region 14, 14′ is particularly advantageous with regard to the clamping effect and enables an even better securing against unintentional release of the cable 2 from the clamped state. As a result of the disproportionate increase in the clear width of the openings 3, 3′ at least in the transition region 29, 29′ compared to the second region 14, 14′, the cable clamp 1 can be configured to be shorter compared to a cable clamp with a linearly varying opening width in the longitudinal extension direction 31. The cable clamp 1 is particularly easy to operate and has a very good clamping effect. Hereinafter particularly preferred values for the openings 3, 3′ of the cable clamp 1 are given in this exemplary embodiment:

0.7*dₛ<w1, w1′<1.2*dₛ

0.3*dₛ<w, w′<0.5*dₛ (for example, the clear width w, w′ can decrease over the width b, b′ from 0.5*dₛ to 0.3*dₛ)

1.1*dₛ<b1, b1′<1.3*dₛ

1.1*dₛ<b, b′<1.4*dₛ

The total width 15 lies in a range between 2.3*dₛ and 2.8*dₛ.

FIG. 14 shows a further preferred embodiment of the cable clamp 1. This has a directional structuring 44, 44′ on the contact surfaces 16, for example in the form of a fluting or texture. The structuring 44, 44′ is preferably oriented in a direction which encloses an angle β, β′ between 0° and 15° with the transverse extension direction 32. The structuring directed in such a manner provides a further improved protection against undesired release.

A structuring oriented parallel to the transverse extension direction 32, i.e. β, β′ equal to 0°, affords an engagement which is tactilely perceptible to the user as a further advantage.

A directional structuring 44, 44′ with angles β, β′>0°, in particular with angles β, β′ between 5° and 15° additionally has the result that the cable portions 4, 4′ are forced towards the respective clamping slot 5, 5′ during displacement of the cable clamp 1. During release of the cable clamp 1 the cable portions 4, 4′ are forced out of the respective clamping slot 5, 5′. The directional structuring therefore provides an additional support for the preferred principle of action forming the basis of the invention whereby the loop 6 exerts an inwardly directed force on the cable portions so that these are forced towards one another into the respective clamping slots.

A cable clamp 1 having a directional structuring 44, 44′ with angles β, β′>0° then has a preferred side on which the loop 6 should then come to lie or a direction in which the cable clamp 1 should be moved for closing and a direction opposite thereto in which the cable clamp 1 should be moved for opening. In embodiments with a tensile element 20 as shown in FIG. 1b, the preferred side is defined by the tensile element 20 (cable clamp moves away from the tensile element 20 during tightening). In embodiments as shown in FIG. 1c a preferred side is also predefined since here a loop 22 is only formed on one side of the cable clamp 1. If the entire fastening element does not make any preferred direction obvious to the user, it is possible to provide the cable clamp 1 and/or the cable 2 with a corresponding feature. By this means, for example, the user can be informed as to which loop 21, 22 he is to place around the object to be fastened.

The specific configuration of the directional structuring 44, 44′, for example, number, geometry (inter alia height, width, length, cross-sectional shape, angle β, β′, spacing of individual structures) can in particular be selected with regard to the sliding friction resulting from the pairing of the material of the cable and the material of the cable clamp, the geometry of the opening 3, 3′, in particular in the second region 14, 14′, the elastic properties of the cable and the force to be applied for tightening/loosening.

One or more rib-like elevations arranged in parallel, for example, on the contact surfaces 16 can be provided as directional structuring 44, 44′, which are raised for example by 0.03*ds to 0.1*ds from the respective contact surface 16. In the case of several rib-like elevations arranged in parallel, these can, for example, have a spacing between 0.1*ds and 0.3*ds. The longitudinal extension direction of the rib-like elevations or ribs corresponds in this case to the direction of the structuring.

In principle, all the body shapes disclosed beyond the examples shown can be combined. Also all the cable clamps can be used in all the indicated embodiments of the arrangement according to the invention. The same applies for the indicated additional features such as clamping ring, connecting element, tensile element, grip structures on the cable clamp etc.

### REFERENCE LIST

1 Cable clamp

2 Cable

3, 3′ Openings

4, 4′ Cable portions

5, 5′ Clamping slots

6 Loop

7 Longitudinal extension

8 Transverse extension

9 Vertical extension

11, 11′ First cable portions

12, 12′ Second cable portions

13, 13′ First region

14, 14′ Second region

15 Extension of the opening in longitudinal extension direction (width)

16 Contact surfaces

17, 17′, 17″ Slit

18 Concave region

19 Connection of the cable ends

20 Connecting element, tensile element

21 First loop

22 Second loop

25 First object

26 Second object

28 Additional element, clamping ring

29, 29′ Transition region

30 Body

31 Longitudinal extension direction

32 Transverse extension direction

33 Vertical extension direction

34, 34′ Penetration direction

35 Surface portions

36, 36′ Ends of cable clamp

37, 37′ Broadened region of cable clamp

38 Grip structure

39, 39′ Securing means

40 Further cable

41, 41′ Widening

43 Elastically stretchable coupling element

44, 44′ Directional structuring

ds Cable diameter

w, w1 Clear widths

b, b1 Widths of the regions

α, α′ Angle between penetration direction and transverse extension direction

β, βR′ Angle which can be assigned to the surface structure in relation to transverse extension direction

γ, γ′ Angle between the normal vectors of opposite contact surfaces n1, n2 or n1′, n2′ n1, n1′, n2,

n2′ Normal vectors to the contact surfaces

1.-12. (canceled)

13. A arrangement comprising:
a cable clamp and at least one cable;
the cable clamp has at least two openings arranged next to one another through which the at least one cable is guided with the formation of two cable portions which pass through the at least two openings;
the openings each having a clamping slot which mutually face an opening region; and
the two cable portions are held outside and adjacent to the openings by a loop of the at least one cable or by a further cable by which the two cable portions are forceable into the clamping slot.

14. The arrangement according to claim 13, wherein:
the at least one cable or the further cable is elastically stretchable or is connected to at least one elastically stretchable coupling element so that an elastic restoring force results which forces the cable portions towards one another into the clamping slots.

15. The arrangement according to claim 13, comprising:
in one piece, cable clamps which comprise a body with a longitudinal extension greater than a transverse extension of the body; and
the openings penetrate the body in a direction of penetration oriented parallel to the transverse extension direction or at an angle<30° relative to a transverse extension direction.

16. The arrangement according to claim 14, comprising:
in one piece, cable clamps which comprise a body with a longitudinal extension greater than a transverse extension of the body; and
the openings penetrate the body in a direction of penetration oriented parallel to the transverse extension direction or at an angle<30° relative to a transverse extension direction.

17. The arrangement according to claim 13, wherein:
each opening has a cross-sectional shape which tapers continuously or stepwise in the direction of the other opening;
the cable has a round cable cross-section having a cable diameter ds, and the cross-sectional shape in the tapered region comprises at least one region having a width with w<0.5 dₛ which is part of the clamping slot.

18. The arrangement according to claim 13, wherein:
the openings are configured to have mirror-symmetrical, and
a vector normal to a plane of symmetry is oriented parallel to a direction of the longitudinal extension.

19. The arrangement according to claim 13, wherein:
each of the slots has at least two mutually facing contact surfaces with which the cable portions come into contact at least during clamping; and
at least one of the contact surfaces has a structured surface structured which increases frictional forces acting between the cable portions and the clamping slots.

20. The arrangement according to claim 17, wherein:
the cable clamp includes a slit completely penetrating the cable clamp, and the openings are interconnected in a region between the clamping slots via the slit so that the cross-sectional shapes of the openings form a single closed contour, or that the cable clamp has two slits making the openings each accessible from outside the slot from a longitudinal extension direction; and
the cable portions are introducable into the openings via the slit or the slits which transversely extend in the penetration direction.

21. The arrangement according to claim 13, wherein:
the cable clamp has surface portions into which the openings open, and the at least one of the surface portions is concave on a side of the loop in a region which contacts the loop.

22. The arrangement according to claim 21, wherein:
cable ends of the at least one cable are connected directly to form a closed cable ring, which on both sides of the cable clamp includes one loop, so that a first loop and a second loop is formed.

23. The arrangement according to claim 16, wherein:
the cable clamp has a first and a second side relative to a plane perpendicular to the transverse extension direction;
on the first side first cable portions adjoin the cable portions and are connected to a first object, on the second side of the cable clamp second cable portions adjoin the cable portions and are interconnected or have at least one means which prevents pulling the second cable portions through the openings; and
the further cable is fixed with loose ends being on the first object or a second object which forms a loop.

24. The arrangement according to claim 13, comprising:
an additional element including at least one through opening through which cable portions emerge from the cable clamp; and
the emerging cable portions have a spacing corresponding to spacing of the cable portions which are guided in the openings when fixed into the clamping slots.

25. The arrangement according to claim 19, wherein:
the surface structuring is spatially directed, and
has at least one rib arranged on the at least one contact surface and which subtends an angle between 0° and 15° relate to a transverse extension direction.
